(19) United States
(12) Patent Application Publication
(10) Pub. No.: US 2024/0039833 A1
(43) Pub. Date: Feb. 1, 2024

(54) MULTI-PATH ROUTING METHOD AND APPARATUS ORIENTED TO SUPERCOMPUTING USER EXPERIENCE QUALITY

(71) Applicant: SHANDONG COMPUTER SCIENCE CENTER (NATIONAL SUPERCOMPUTER CENTER IN JINAN), Jinan (CN)

(72) Inventors: Huiling SHI, Jinan (CN); Yan ZHOU, Jinan (CN); Meihong YANG, Jinan (CN); Wei ZHANG, Jinan (CN); Yuhan ZHAO, Jinan (CN)

(73) Assignee: SHANDONG COMPUTER SCIENCE CENTER (NATIONAL SUPERCOMPUTER CENTER IN JINAN), Jinan (CN)

(21) Appl. No.: 18/265,274

(22) PCT Filed: Dec. 29, 2020
(86) PCT No.: PCT/CN2020/140817

§ 371 Date: Jun. 5, 2023

(30) Foreign Application Priority Data
Dec. 7, 2020 (CN) 202011437644.9

(51) Int. Cl. H04L 45/24; H04L 45/302; H04L 45/122

(52) U.S. Cl. CPC H04L 45/24; H04L 45/308; H04L 45/122

(57) ABSTRACT

A multi-path routing method oriented to supercomputing user experience quality includes: decoupling, according to a preset rule, a service with a path to be planned into at least one service block; acquiring, according to a network requirement feature of each service block, all paths between network nodes of the path to be planned, and a network feature of each of all the paths, a multi-path set between the network nodes for the service; and inputting the network feature of each path in the multi-path set and the network requirement features of all the service blocks into a preset matching degree evaluation function to acquire a network path between the network nodes for the service. According to the multi-path routing method, the overall service of the network is described in blocks, so that a strong dependency relationship between supercomputing service task scheduling and data exchange is decoupled.

### CROSS REFERENCE TO THE RELATED APPLICATIONS

This application is the national phase entry of International Application No. PCT/CN2020/140817, filed on Dec. 29, 2020, which is based upon and claims priority to Chinese Patent Application No. 202011437644.9, filed on Dec. 7, 2020, the entire contents of which are incorporated herein by reference.

### TECHNICAL FIELD

The present invention relates to the field of network communication technologies, and in particular, to a multi-path routing method and apparatus oriented to supercomputing user experience quality.

### BACKGROUND

At present, in common multi-path routing methods, equal-cost multi-path routing (ECMP) is usually used. The ECMP is based on data streams or data packets, but does not consider differences in network features, such as bandwidth, delay and reliability, of respective paths in a network as well as differences in property characteristics of the data streams or the data packets. Therefore, when the difference between the paths is large or the data stream requirements are very different, the effect is not ideal.

### SUMMARY

A technical problem to be solved by the present invention is to provide a multi-path routing method and apparatus oriented to supercomputing user experience quality, for defects in the prior art.

The technical solution of the present invention for solving the above technical problem is as follows.

A multi-path routing method oriented to supercomputing user experience quality includes:
decoupling, according to a preset rule, a service with a path to be planned into at least one service block, and acquiring a network requirement feature of each service block;
acquiring, according to the network requirement feature of each service block, all paths between network nodes of the path to be planned, and a network feature of each of all the paths, a multi-path set between the network nodes for the service; and
inputting the network feature of each path in the multi-path set and the network requirement features of all the service blocks into a preset matching degree evaluation function to acquire a network path between the network nodes for the service.

The method of the present invention has the following beneficial effects. The multi-path routing method oriented to supercomputing user experience quality is provided: by means of the preset rule, the service with the path to be planned is decoupled into at least one service block and the network requirement feature of each service block is acquired; according to the network requirement feature of each service block, all paths between network nodes of the path to be planned, and the network feature of each of all the paths, the multi-path set between the network nodes for the service is acquired; and the network feature of each path in the multi-path set and the network requirement features of all the service blocks are inputted into the preset matching degree evaluation function to acquire the network path between the network nodes for the service. According to the present invention, based on practical supercomputing applications, multi-dimensional and fine-grained requirements of different supercomputing applications or services for a network are formally described and the overall service of the network is described in blocks, so that a strong dependency relationship between supercomputing service task scheduling and data exchange can be decoupled to the greatest extent, thereby improving the user experience.

Based on the above technical solution, the following improvement can further be made on the present invention.

Further, said acquiring, according to the network requirement feature of each service block, all paths of the service, and the network feature of each of all the paths, the multi-path set of the service specifically includes:
determining, according to the network requirement feature of the service block, a first encoding vector for characterizing the network requirement feature of the service block;
calculating a distance between the first encoding vector of the service block and a second encoding vector of each of the paths respectively to acquire a corresponding distance between the service block and each path, wherein the second encoding vector is an encoding vector for characterizing the network feature of the path;
selecting, from all the paths, at least one path whose distance is less than a preset distance threshold, to acquire a candidate path between the network nodes for the service block;
determining, according to the first encoding vectors of all the service blocks and the second encoding vector of the candidate path, feature matching degrees between the candidate path and all the service blocks in a plurality of preset dimensions; and
determining the candidate paths whose feature matching degree meets a preset requirement as the multi-path set between the network nodes for the service.

The beneficial effect achieved by adopting the above further solution is that: by converting the network requirement feature of each service block to the first encoding vector and the network feature of each path to the second encoding vector and calculating the distance between the first encoding vector and the second encoding vector, the multi-path set between the network nodes for the service is determined, so that the matching degree between the service blocks and the paths in the multi-path set is improved.

Further, said determining, according to the first encoding vectors of all the service blocks and the second encoding vector of the candidate path, the feature matching degrees between the candidate path and all the service blocks in the plurality of preset dimensions specifically includes:
constructing a feature vector that characterizes a feature relationship between the candidate path and all the service blocks by using the first encoding vectors of all the service blocks and the second encoding vector of the candidate path; and
determining the feature matching degrees between the candidate path and all the service blocks according to the feature vector and by using a pre-established classification model.

The beneficial effect achieved by adopting the above further solution is that: the feature matching degrees between the candidate path and all the service blocks is determined by using the first encoding vectors of all the service blocks, the second encoding vector of the candidate path and the pre-established classification model, so that the accuracy of the feature matching degree is improved.

Further, said constructing the feature vector that characterizes the feature relationship between the candidate path and all the service blocks by using the first encoding vectors of all the service blocks and the second encoding vector of the candidate path specifically includes:
combining the first encoding vectors of all the service blocks and the second encoding vector of the candidate path into a multi-dimensional vector; and
determining the multi-dimensional vector as the feature vector that characterizes the feature relationship between the candidate path and all the service blocks, wherein a dimension of the feature vector is a sum of the dimensions of the first encoding vectors and the second encoding vector.

The beneficial effect achieved by adopting the above further solution is that: by combining the first encoding vectors of all the service blocks and the second encoding vector of the candidate path into the multi-dimensional vector, the matching degree between the service block and the path is improved.

Further, said determining, according to the network requirement feature of the service block, the first encoding vector for characterizing the network requirement feature of the service block includes:
ranking, according to different priorities of the network requirement features of the service blocks, the network requirement features of the service blocks to acquire a first network feature sequence;
sequentially determining feature values of respective network features in the first network feature sequence; and
constructing, according to the feature values of the respective network features in the first network feature sequence, the first encoding vector for characterizing the service block.

The beneficial effect achieved by adopting the above further solution is that: according to different priorities of the network requirement features of the service blocks, the network requirement features of the service blocks are ranked, so that the first encoding vector acquired finally better meets the actual requirements of the service blocks.

Further, said constructing, according to the feature values of the respective network features in the first network feature sequence, the first encoding vector for characterizing the service block includes:
inputting the feature values of the respective network features in the first network feature sequence into a trained vector conversion model; and
acquiring the first encoding vector outputted by the vector conversion model, wherein the vector conversion model is acquired by training with a plurality of positive samples and a plurality of negative samples.

The beneficial effect achieved by adopting the above further solution is that: by converting the encoding vector by the vector conversion model trained in advance, the encoding vectors of the service blocks can be acquired accurately.

Another technical solution of the present invention for solving the above technical problem is as follows.

A multi-path routing apparatus oriented to supercomputing user experience quality includes:
a decoupling module configured to: decouple, according to a preset rule, a service with a path to be planned into at least one service block and acquire a network requirement feature of each service block;
a matching module configured to: acquire a multi-path set of the service according to the network requirement feature of each service block, all paths of the service, and a network feature of each of all the paths; and
an evaluation module configured to input the network feature of each path in the multi-path set and the network requirement features of all the service blocks into a preset matching degree evaluation function to acquire a network path of the service.

The apparatus of the present invention has the beneficial effects as follows. The multi-path routing apparatus oriented to supercomputing user experience quality is provided: by means of the preset rule, the service with the path to be planned is decoupled into at least one service block and the network requirement feature of each service block is acquired; according to the network requirement feature of each service block, all paths between the network nodes of the path to be planned, and the network feature of each of all the paths, the multi-path set between the network nodes for the service is acquired; and the network feature of each path in the multi-path set and the network requirement features of all the service blocks are inputted into the preset matching degree evaluation function to acquire the network path between the network nodes for the service, According to the present invention, based on practical supercomputing applications, multi-dimensional and fine-grained requirements of different supercomputing applications or services for a network are formally described and the overall service of the network is described in blocks, so that a strong dependency relationship between supercomputing service task scheduling and data exchange can be decoupled to the greatest extent, thereby improving the user experience.

Further, the matching module is specifically configured to: determine, according to the network requirement feature of the service block, a first encoding vector for characterizing the network requirement feature of the service block;
calculate a distance between the first encoding vector of each service block and a second encoding vector of each of the paths respectively to acquire a corresponding distance between the service block and each path, wherein the second encoding vector is an encoding vector for characterizing the network feature of the path;
select, from all the paths, at least one path whose distance is less than a preset distance threshold, to acquire a candidate path for the service block;
determine, according to the first encoding vectors of all the service blocks and the second encoding vector of the candidate path, feature matching degrees between the candidate path and all the service blocks in a plurality of preset dimensions; and

determine the candidate path whose feature matching degree meets a preset requirement as the multi-path set of the service.

The present application further provides a computer-readable storage medium including an instruction, wherein when the instruction runs on a computer, the computer is caused to execute the steps in the multi-path routing method oriented to supercomputing user experience quality according to any of the above technical solutions.

In addition, the present application further provides a computer device, including a memory, a processor and a computer program which is stored in the memory and may run on the processor, wherein when the processor executes the program, the steps in the multi-path routing method oriented to supercomputing user experience quality according to any of the above technical solutions are implemented.

Advantages of additional aspects of the present invention will be partially given in the following description and will be partially obvious from the following description, or learned by practice of the present invention.

### BRIEF DESCRIPTION OF THE DRAWINGS

In order to describe the technical solutions of the embodiments of the present invention more clearly, the following briefly introduces the accompanying drawings required for describing the embodiments of the present invention or the prior art. Apparently, the accompanying drawings in the following description show merely some embodiments of the present invention, and those of ordinary skill in the art may also derive other drawings from these accompanying drawings without creative efforts.

FIG. 1 is a schematic flowchart of a multi-path routing method oriented to supercomputing user experience quality according to an embodiment of the present invention; and

FIG. 2 is a schematic diagram of modules of a multi-path routing apparatus oriented to supercomputing user experience quality according to another embodiment of the present invention.

### DETAILED DESCRIPTION OF THE EMBODIMENTS

The technical solutions in the embodiments of the present invention will be clearly and completely described below with reference to the accompanying drawings in the embodiments of the present invention. Obviously, the embodiments described are some but not all embodiments of the present invention. Based on the embodiments of the present invention, all other embodiments derived by those of ordinary skill in the art without creative efforts shall fall within the protection scope of the present invention.

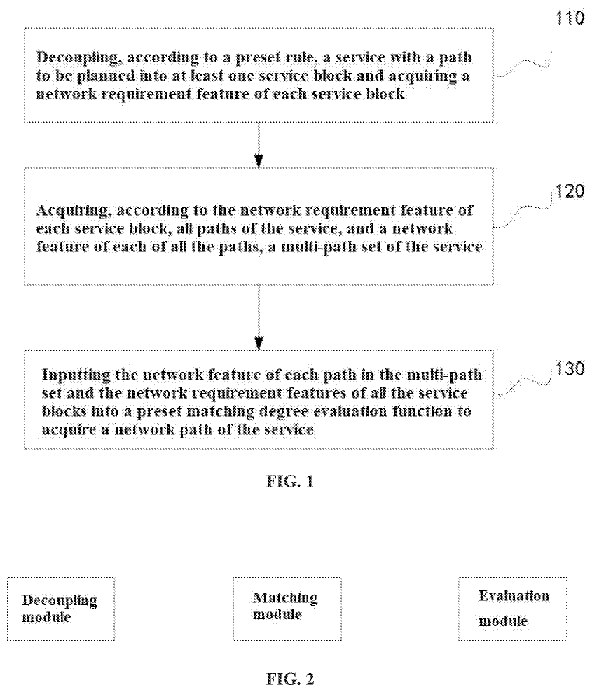

As shown in FIG. 1, which shows a schematic flowchart of a multi-path routing method oriented to supercomputing, user experience quality according to an embodiment of the present invention, the multi-path routing method oriented to supercomputing user experience quality includes the following steps.

In 110, according to a preset rule, a service with a path to be planned is decoupled into at least one service block and a network requirement feature of each service block is acquired.

It should be understood that in this embodiment, a service F is decoupled into N blocks, and each block is denoted as Fᵢ, where 1<i<N. Actual network requirement features of the known service F include a bandwidth, a scheduling time, a data exchange volume, etc. There are M reachable paths from a node A to a node B in a network G, and a network feature of each path includes residual bandwidth, delay, etc. How to choose, from a multidimensional perspective, i.e., the bandwidth, the scheduling time, and the data exchange volume and according to a matching degree between the network features of the paths and actual service requirements, K paths from the M reachable paths to allocate routing paths for the service? In this embodiment, the preset rule may be that the service is decoupled on the basis of data and control levels, or of the actual network requirement features of the service.

In 120, according to the network requirement feature of each service block, all paths of the service, and a network feature of each of all the paths, a multi-path set of the service is acquired.

It should be understood that in this embodiment, multi-dimensional and fine-grained requirements of different supercomputing, applications or services for the network may be formally described based on actual supercomputing applications, and the overall service of the network is described in blocks. For example, some services require a delay of no more than 10 ns and a bandwidth of no less than 1 Mbps, while others require a delay of no more than 1 ns and a cumulative bandwidth of no less than 500 Mbps. According to a multi-dimensional and fine-grained requirement description method, a plurality of sets of network features are respectively matched with different network paths. Specifically, the following scheme may be used in specific matching: a description is given by preliminarily considering three dimensions: the bandwidth, a scheduling time constraint and a data exchange volume which are required for an actual service, and the network requirement features of the service block Fⱼ are defined as Cfⱼ (1), Cfⱼ (2) and Cfⱼ (3). Assuming that the service block Fⱼ has n paths between network nodes, which are defined as Pfⱼ(1), Pfⱼ(2), . . . Pfⱼ(n), PCf (ij) is acquired according to the bandwidth B and delay Dᵢ of each path and the network requirement feature of the service block Fⱼ, where PCf(ij) means whether the bandwidth and delay of the network path i meet the requirements of the service block Fⱼ. Thus, a multi-path set definition is acquired.

In 130, the network feature of each path in the multi-path set and the network requirement features of all service blocks are inputted into a preset matching degree evaluation function to acquire a network path of the service.

It should be understood that there is a plurality of matching modes for the plurality of paths in the multi-path set, and the following matching degree evaluation function is used,

$$D ( FPC ) = {\sum }_{i = 1}^{ik} {f}_{i} ( {P}_{i} ) ,$$

where fᵢ(Pᵢ) represents the matching degree between the network path Pᵢ and the service block. In this embodiment, the corresponding object and evaluation function may also be updated on the basis of demand indicators of user experience quality.

In the above the multi-path routing method oriented to supercomputing user experience quality provided by the above embodiment, according to the preset rule, the service with the path to be planned is decoupled into the at least one service block, and the network requirement feature of each service block is acquired; according to the network requirement feature of each service block, all paths between the network nodes of the path to be planned, and the network feature of each of all the paths, the multi-path set between the network nodes for the service is acquired; and the network feature of each path in the multi-path set and the network requirement features of all the service blocks are inputted into the preset matching degree evaluation function to acquire the network path between the network nodes for the service. In this embodiment, based on actual supercomputing applications, multidimensional and fine-grained requirements of different supercomputing applications or services for the network are formally described and the overall service of the network is described in blocks, so that a strong dependency relationship between supercomputing service task scheduling and data exchange can be decoupled to the greatest extent, thereby improving the user experience.

Further, step 120 specifically includes the following steps.

In 121, a first encoding vector for characterizing the network requirement feature of the service block is determined according to the network requirement feature of the service block.

In 122, a distance between the first encoding vector of the service block and a second encoding vector of each path is respectively calculated to acquire a corresponding distance between the service block and each path, wherein the second encoding vector is an encoding vector for characterizing the network feature of the path.

It should be understood that the distance between the first encoding vector and the second encoding vector may also be referred to as a vector distance. The vector distance may have various forms. For example, a Euclidean distance or a Manhattan distance between the first and second encoding vectors may be calculated.

It may be understood that for each standard entity name, the vector distance between the first encoding vector of the entity name and the second encoding vector of the standard entity name needs to be calculated. Therefore, each standard entity name corresponds to one vector distance, while a plurality of standard entity names corresponds to a plurality of vector distances.

In 123, at least one path whose distance is less than a preset distance threshold is selected from all the paths to acquire a candidate path of the service block.

It may be understood that if the distance between the second encoding vector and the first encoding vector of the service block is small, it indicates that this path is a path that best meets the network requirement feature of the service block.

In 124, feature matching degrees between the candidate path and all the service blocks in a plurality of preset dimensions are determined according to the first encoding vectors of all the service blocks and the second encoding vector of the candidate path.

It may be understood that the first encoding vector reflects the network requirement feature of the service block, while the second encoding vector reflects the network feature of the candidate path. Therefore, for each service block, it is necessary to analyze the feature matching degree between the service block and the candidate path in a plurality of preset dimensions according to the first encoding vector and the second encoding vector.

The plurality of preset dimensions may be set as needed. For example, the plurality of preset dimensions may be a plurality of dimensions that reflects different network features. In this way, from the perspective of a plurality of information categories, in conjunction with the first encoding vector and the second encoding vector, the feature matching degree between the service block and the path in the corresponding dimensions may be analyzed.

In 125, the candidate path whose feature matching degree meets a preset requirement is determined as the multi-path set.

Further, step 124 specifically includes the following steps:
1241, constructing a feature vector that characterizes a feature relationship between the candidate path and all the service blocks by using the first encoding vectors of all the service blocks and the second encoding vector of the candidate path; and
1242, determining the feature matching degrees between the candidate path and all the service blocks according to the feature vector and by using a pre-established classification model.

It may be understood that in the embodiment of the present application, there may be a plurality of modes to determine the feature matching degrees between the candidate path and all the service blocks according to the feature vector and by using the pre-established classification model.

Optionally, in order to determine the feature matching degree more conveniently and efficiently, in practical application, a classification model may also be trained. For example, the classification model is trained through a machine learning algorithm.

It may be understood that the feature vector that characterizes the feature relationship between the candidate path and all the service blocks may be constructed first by using the first encoding vectors of the service blocks and the second encoding vector of the candidate path; and then, the constructed feature vector is inputted into the classification model trained in advance, and the feature matching degrees between the candidate path and the service blocks in the plurality of preset dimensions are predicted through the classification model.

Further, step 1241 specifically includes:
combining the first encoding vectors of all the service blocks and the second encoding vector of the candidate path into a multi-dimensional vector; and
determining the multi-dimensional vector as a feature vector that characterizes the feature relationship between the candidate path and all the service blocks, wherein a dimension of the feature vector is a sum of the dimensions of the first encoding vectors and the second encoding vector.

Further, step 121 includes:
1211, ranking, according to different priorities of the network requirement features of the service blocks, the network requirement features of the service blocks to acquire a first network feature sequence;
1212, sequentially determining feature values of respective network features in the first network feature sequence; and
1213, constructing, according to the feature values of the respective network features in the first network feature sequence, the first encoding vector for characterizing the service block.

Further, step 1213 includes the following steps:
inputting the feature values of the respective network features in the first network feature sequence into a trained vector conversion model; and
acquiring the first encoding vector outputted by the vector conversion model, wherein the vector conversion model is obtained by training.

It should be understood that the vector conversion model is a neural network model trained in advance, and a specifically used neural network model is selected according to actual needs.

For example, for certain game service running on the network, the game service F is decoupled into a control module, an upgrade module, a resource module, and a graphics processing module. As the control module involves controlling a game process by a player, in order to meet the game experience of the player, the control module requires a relatively high bandwidth and a relatively short invoking time constraint: the bandwidth and the invoking time constraint which are required for the control module are 1 Mops and 10 ns respectively. The network requirement features for the control module F₁ are defined as Cf₁(1) and Cf₁(2), which represent the bandwidth and the invoking time constraint required for the control module, respectively. For the user, the upgrade module does not require as much as the control module, and the bandwidth and the invoking time constraint which are required for the upgrade module are 200 kbps and 100 ns respectively. The network requirement features of the upgrade module F₂ are defined as Cf₂(1) and Cf₂(2). Assuming that between network nodes, the control module F₁ has n paths defined as Pf₁(1), Pf₁(2), . . . , Pf₁(n). According to the bandwidth B and delay D of each path and the network requirement features Cf₁(1) and Cf₁(2) of the control module F₁, PCf(i1) is acquired, where PCf(i1) means that the bandwidth and delay of a network path i meet the requirements of the control service F₁. Similarly, PCf(ⱼ₂) is acquired, where PCf(ⱼ₂) means that the bandwidth and delay of a network path j meet the requirements of an upgrade service F₂. The paths i and j are put in the multi-path set to acquire a multi-path set for a game service. The network feature of each path in the mull-path set and the network requirement features of all service blocks are inputted into the preset matching degree evaluation function to finally acquire a network path for this game service. As shown in FIG. 2, which shows a schematic diagram of modules of a multi-path routing apparatus oriented to supercomputing user experience quality according to another embodiment of the present invention, the multi-path routing apparatus oriented to supercomputing user experience quality includes:
a decoupling module configured to: decouple, according to a preset rule, a service with a path to be planned into at least one service block and acquire a network requirement feature of each service block;
a matching module configured to: acquire, according to the network requirement feature of each service block, all paths between network nodes of the path to be planned, and a network feature of each of all the paths, a multi-path set between the network nodes for the service; and
an evaluation module configured to input the network feature of each path in the multi-path set and the network requirement features of all the service blocks into a preset matching degree evaluation function to acquire a network path between the network nodes for the service.

Further, the matching module is specifically configured to: determine, according to the network requirement feature of the service block, a first encoding vector for characterizing the network requirement feature of the service block;
calculate a distance between the first encoding vector of the service block and a second encoding vector of each of the paths respectively to acquire a corresponding distance between the service block and each path, wherein the second encoding vector is an encoding vector for characterizing the network feature of the path;
select, from all the paths, at least one path whose distance is less than a preset distance threshold, to acquire a candidate path between the network nodes for the service block;
determine, according to the first encoding vectors of all the service blocks and the second encoding vector of the candidate path, feature matching degrees between the candidate path and all the service blocks in a plurality of preset dimensions; and
determine the candidate paths whose feature matching degree meets a preset requirement as the multi-path set between the network nodes for the service.

Further, the matching module is specifically configured to: construct a feature vector that characterizes a feature relationship between the candidate path and all the service blocks by using the first encoding vectors of all the service blocks and the second encoding vector of the candidate path; and
determine the feature matching degrees between the candidate path and all the service blocks according to the feature vector and by using a pre-established classification model.

Further, the matching module is specifically configured to: combine the first encoding vectors of all the service blocks and the second encoding vector of the candidate path into a multi-dimensional vector; and
determine the multi-dimensional vector as the feature vector that characterizes the feature relationship between the candidate path and all the service blocks, wherein a dimension of the feature vector is a sum of the dimensions of the first encoding vectors and the second encoding vector.

Further, the matching module is specifically configured to: rank, according to different priorities of the network requirement features of the service blocks, the network requirement features of the service blocks to acquire a first network feature sequence;
sequentially determine feature values of respective network features in the first network feature sequence; and
construct, according to the feature values of the respective network features in the first network feature sequence, the first encoding vector for characterizing the service block.

Further, the matching module is specifically configured to: input the feature values of the respective network features in the first network feature sequence into a trained vector conversion model; and
acquire the first encoding vector outputted by the vector conversion model, wherein the vector conversion model is acquired by training with a plurality of positive samples and a plurality of negative samples.

In addition, the present application further provides a computer-readable storage medium including instructions. When the instructions run on a computer, the computer is caused to execute the steps in the multi-path routing method oriented to supercomputing user experience quality according to any of the above technical solutions.

In addition, the present application further provides a computer device, including a memory, a processor and a computer program which is stored in the memory and may run on the processor. When the processor executes the program, the steps in the multi-path routing method oriented to supercomputing user experience quality according to any of the above technical solutions are implemented.

A person skilled in the art may clearly understand that for the sake of convenience and conciseness in description, only division of all the functional units or modules above is taken as an example for explanation. In practice, the above functions may be allocated by different functional units or modules as required. That is, the internal structure of the apparatus is divided into different functional units or modules to accomplish all or part of the functions described above. All functional units or modules in the embodiments may be integrated into one processing unit; or each unit exists physically independently; or two or more units may be integrated into one unit. The above integrated units may be implemented in the form of hardware or a software function unit. In addition, the specific names of the various functional units or modules are only for facilitating distinguishing them from each other, and are not intended to limit the protection scope of the present application. The specific work processes of the above units or modules in the above system may refer to corresponding processes in the above method embodiment and are not further described herein.

In the above embodiments, the description of each embodiment has its own emphasis. The parts that are not detailed or described in certain embodiment may refer to related description of other embodiments.

It should be appreciated by those of ordinary skill in the art that units and algorithm steps of various examples described in conjunction with the embodiments disclosed herein may be implemented as electronic hardware, or a combination of computer software and electronic hardware. Whether these functions are implemented as hardware or software depends on particular applications and design constraints of the technical solutions. A person skilled in the art may implement the described functions with different methods for each of particular applications, but such implementation shall not be regarded as going beyond the scope of the present invention.

In the embodiments provided by the present invention, it should be understood that the disclosed apparatus/terminal device and method may be implemented by other means. For example, the apparatus/terminal device embodiments described above are merely schematic. For example, the division of the modules or units may be a logical functional division. There may be other division modes during actual implementation. For example, multiple units or components may be combined or integrated into another system, or some features may be ignored or not executed. In addition, mutual coupling or direct coupling or communication connection that is shown or discussed may be indirect coupling or communication connection through some interfaces, apparatuses or units; or may be in electrical, mechanical or other forms.

The units described as separated components may be or may not be physically separated. The components displayed as units may be or may not be physical units, that is, may be located in one place or may be distributed on a plurality of network units. Part or all of the units may be selected according to actual needs to achieve the purposes of the solutions of the embodiments.

In addition, all functional units in the embodiments of the present invention may be integrated into one processing unit; or, each unit exists physically independently; or two or more units may be integrated into one unit. The above integrated units may be implemented in the form of hardware or a software function unit.

The integrated modules/units, if implemented in the form of the software function units and sold or used as independent products, may be stored in a computer-readable storage medium.

Based on this understanding, all or part of the processes for implementing the method of the above embodiment of the present invention may also be completed by instructing relevant hardware through a computer program. The computer program may be stored in a computer-readable storage medium, and when the computer program is executed by a processor, the steps of the above various method embodiments can be implemented. The computer program includes a computer program code, and the computer program code may be in the form of a source code, an object code and an executable file or some intermediate form, and the like. The computer-readable medium may include: any entity or apparatus capable of carrying the computer program code, a recording medium, a U disk, a mobile hard disk, a magnetic disk, an optical disk, a computer memory, a read-only memory (ROM), a random access memory (RAM), an electrical carrier signal, a telecommunication signal and a software distribution medium, etc. It should be noted that the content contained in the computer-readable medium may be appropriately increased or decreased according to the requirements of legislation and patent practice in the jurisdiction. For example, in some jurisdictions, according to the legislation and patent practice, the computer-readable medium includes no electrical carrier signal and no telecommunication signal.

The above embodiments are only intended to describe the technical solutions of the present invention and are not intended to limit the present invention. Although the present invention is described in detail with reference to the foregoing embodiments, it may be understood by those of ordinary skill in the art that they can still make modifications to the technical solutions disclosed in the above various embodiments or equivalent replacements on part of technical features, and these modifications or replacements do not depart the nature of the corresponding technical solution from the spirit and scope of the technical solutions of the various embodiments of the present invention and should be included within the protection scope of the present invention.

What is claimed is:

1. A multi-path routing method oriented to supercomputing user experience quality, comprising:
decoupling, according to a preset rule, a service with a path to be planned into at least one service block and acquiring a network requirement feature of each service block;
acquiring a multi-path set between the network nodes for the service according to the network requirement feature of each service block, all paths between network nodes of the path to be planned, and a network feature of each of all the paths; and
inputting the network feature of each path in the multi-path set and the network requirement features of all the service blocks into a preset matching degree evaluation function to acquire a network path between the network nodes for the service.

2. The multi-path routing method oriented to supercomputing user experience quality according to claim 1, wherein the step of acquiring the multi-path set between the network nodes for the service according to the network requirement feature of each service block, all the paths between the network nodes of the path to be planned, and the network feature of each of all the paths comprises:
determining, according to the network requirement feature of the service block, a first encoding vector for characterizing the network requirement feature of the service block;
calculating a distance between the first encoding vector of the service block and a second encoding vector of each of the paths respectively to acquire a corresponding distance between the service block and each path, wherein the second encoding vector is configured for characterizing the network feature of the path;
selecting, from all the paths, at least one path whose distance is less than a preset distance threshold to acquire a candidate path between the network nodes for the service block;
determining, according to the first encoding vectors of all the service blocks and the second encoding vector of the candidate path, feature matching degrees between the candidate path and all the service blocks in a plurality of preset dimensions; and
determining the candidate paths whose feature matching degree meets a preset requirement as the multi-path set between the network nodes for the service.

3. The multi-path routing method oriented to supercomputing user experience quality according to claim 2, wherein the step of determining, according to the first encoding vectors of all the service blocks and the second encoding vector of the candidate path, the feature matching degrees between the candidate path and all the service blocks in the plurality of preset dimensions comprises:
constructing a feature vector configured to characterize a feature relationship between the candidate path and all the service blocks by using the first encoding vectors of all the service blocks and the second encoding vector of the candidate path; and
determining the feature matching degrees between the candidate path and all the service blocks according to the feature vector and by using a pre-established classification model.

4. The multi-path routing method oriented to supercomputing user experience quality according to claim 3, wherein the step of constructing the feature vector configured to characterize the feature relationship between the candidate path and all the service blocks by using the first encoding vectors of all the service blocks and the second encoding vector of the candidate path comprises:
combining the first encoding vectors of all the service blocks and the second encoding vector of the candidate path into a multi-dimensional vector; and
determining the multi-dimensional vector as the feature vector configured to characterize the feature relationship between the candidate path and all the service blocks, wherein a dimension of the feature vector is a sum of dimensions of the first encoding vectors and the second encoding vector.

5. The multi-path routing method oriented to supercomputing user experience quality according to claim 2, wherein the step of determining, according to the network requirement feature of the service block, the first encoding vector for characterizing the network requirement feature of the service block comprises:
ranking, according to different priorities of the network requirement features of the service blocks, the network requirement features of the service blocks to acquire a first network feature sequence;
sequentially determining feature values of respective network features in the first network feature sequence; and
constructing, according to the feature values of the respective network features in the first network feature sequence, the first encoding vector for characterizing the service block.

6. The multi-path routing method oriented to supercomputing user experience quality according to claim 5, wherein the step of constructing, according to the feature values of the respective network features in the first network feature sequence, the first encoding vector for characterizing the service block comprises:
inputting the feature values of the respective network features in the first network feature sequence into a trained vector conversion model; and
acquiring the first encoding vector outputted by the trained vector conversion model, wherein the trained vector conversion model is acquired by training with a plurality of positive samples and a plurality of negative samples.

7. A multi-path routing apparatus oriented to supercomputing user experience quality, comprising:
a decoupling module configured to: decouple, according to a preset rule, a service with a path to be planned into at least one service block and acquire a network requirement feature of each service block;
a matching module configured to: acquire a multi-path set between the network nodes for the service according to the network requirement feature of each service block, all paths; and
an evaluation module configured to input the network feature of each path in the multi-path set and the network requirement features of all the service blocks into a preset matching degree evaluation function to acquire a network path between the network nodes for the service.

8. The multi-path routing apparatus oriented to supercomputing user experience quality according to claim 7, wherein
the matching module is configured to:
determine, according to the network requirement feature of the service block, a first encoding vector for characterizing the network requirement feature of the service block;
calculate a distance between the first encoding vector of the service block and a second encoding vector of each of the paths respectively to acquire a corresponding distance between the service block and each path, wherein the second encoding vector is configured for characterizing the network feature of the path;
select, from all the paths, at least one path whose distance is less than a preset distance threshold to acquire a candidate path between the network nodes for the service block;
determine, according to the first encoding vectors of all the service blocks and the second encoding vector of the candidate path, feature matching degrees between the candidate path and all the service blocks in a plurality of preset dimensions; and
determine the candidate paths whose feature matching degree meets a preset requirement as the multi-path set between the network nodes for the service.

9. A computer device, comprising a memory, a processor and a computer program, wherein the computer program is stored in the memory and configured to run on the processor, wherein when the processor executes the computer program, a computer is allowed to execute the multi-path routing method oriented to supercomputing user experience quality according to claim 1.

10. A storage medium, configured to store an instruction therein, wherein when reading the instruction, a computer is allowed to execute the multi-path routing method oriented to supercomputing user experience quality according to claim 1.

11. The computer device according to claim 9, wherein in the multi-path routing method oriented to supercomputing user experience quality, the step of acquiring the multi-path set between the network nodes for the service according to the network requirement feature of each service block, all the paths between the network nodes of the path to be planned, and the network feature of each of all the paths comprises:
determining, according to the network requirement feature of the service block, a first encoding vector for characterizing the network requirement feature of the service block;
calculating a distance between the first encoding vector of the service block and a second encoding vector of each of the paths respectively to acquire a corresponding distance between the service block and each path, wherein the second encoding vector is configured for characterizing the network feature of the path;
selecting, from all the paths, at least one path whose distance is less than a preset distance threshold to acquire a candidate path between the network nodes for the service block;
determining, according to the first encoding vectors of all the service blocks and the second encoding vector of the candidate path, feature matching degrees between the candidate path and all the service blocks in a plurality of preset dimensions; and
determining the candidate paths whose feature matching degree meets a preset requirement as the multi-path set between the network nodes for the service.

12. The computer device according to claim 11, wherein in the multi-path routing method oriented to supercomputing user experience quality, the step of determining, according to the first encoding vectors of all the service blocks and the second encoding vector of the candidate path, the feature matching degrees between the candidate path and all the service blocks in the plurality of preset dimensions comprises:
constructing a feature vector configured to characterize a feature relationship between the candidate path and all the service blocks by using the first encoding vectors of all the service blocks and the second encoding vector of the candidate path; and
determining the feature matching degrees between the candidate path and all the service blocks according to the feature vector and by using a pre-established classification model.

13. The computer device according to claim 12, wherein in the multi-path routing method oriented to supercomputing user experience quality, the step of constructing the feature vector configured to characterize the feature relationship between the candidate path and all the service blocks by using the first encoding vectors of all the service blocks and the second encoding vector of the candidate path comprises:
combining the first encoding vectors of all the service blocks and the second encoding vector of the candidate path into a multi-dimensional vector; and
determining the multi-dimensional vector as the feature vector configured to characterize the feature relationship between the candidate path and all the service blocks, wherein a dimension of the feature vector is a sum of dimensions of the first encoding vectors and the second encoding vector.

14. The computer device according to claim 11, wherein in the multi-path routing method oriented to supercomputing user experience quality, the step of determining, according to the network requirement feature of the service block, the first encoding vector for characterizing the network requirement feature of the service block comprises:
ranking, according to different priorities of the network requirement features of the service blocks, the network requirement features of the service blocks to acquire a first network feature sequence;
sequentially determining feature values of respective network features in the first network feature sequence; and
constructing, according to the feature values of the respective network features in the first network feature sequence, the first encoding vector for characterizing the service block.

15. The computer device according to claim 14, wherein in the multi-path routing method oriented to supercomputing user experience quality, the step of constructing, according to the feature values of the respective network features in the first network feature sequence, the first encoding vector for characterizing the service block comprises:
inputting the feature values of the respective network features in the first network feature sequence into a trained vector conversion model; and,
acquiring the first encoding vector outputted by the trained vector conversion model, wherein the trained vector conversion model is acquired by training with a plurality of positive samples and a plurality of negative samples.

16. The storage medium according to claim 10, wherein in the multi-path routing method oriented to supercomputing user experience quality, the step of acquiring the multi-path set between the network nodes for the service according to the network requirement feature of each service block, all the paths between the network nodes of the path to be planned, and the network feature of each of all the paths comprises:
determining, according to the network requirement feature of the service block, a first encoding vector for characterizing the network requirement feature of the service block;
calculating a distance between the first encoding vector of the service block and a second encoding vector of each of the paths respectively to acquire a corresponding distance between the service block and each path, wherein the second encoding vector is configured for characterizing the network feature of the path;
selecting, from all the paths, at least one path whose distance is less than a preset distance threshold to acquire a candidate path between the network nodes for the service block;
determining, according to the first encoding vectors of all the service blocks and the second encoding vector of the candidate path, feature matching degrees between the candidate path and all the service blocks in a plurality of preset dimensions; and
determining the candidate paths whose feature matching degree meets a preset requirement as the multi-path set between the network nodes for the service.

17. The storage medium according to claim 16, wherein the step of determining, according to the first encoding vectors of all the service blocks and the second encoding vector of the candidate path, the feature matching degrees between the candidate path and all the service blocks in the plurality of preset dimensions comprises:
constructing a feature vector configured to characterize a feature relationship between the candidate path and all the service blocks by using the first encoding vectors of all the service blocks and the second encoding vector of the candidate path; and
determining the feature matching degrees between the candidate path and all the service blocks according to the feature vector and by using a pre-established classification model.

18. The storage medium according to claim 17, wherein the step of constructing the feature vector configured to characterize the feature relationship between the candidate path and all the service blocks by using the first encoding vectors of all the service blocks and the second encoding vector of the candidate path comprises:
combining the first encoding vectors of all the service blocks and the second encoding vector of the candidate path into a multi-dimensional vector; and
determining the multi-dimensional vector as the feature vector configured to characterize the feature relationship between the candidate path and all the service blocks, wherein a dimension of the feature vector is a sum of dimensions of the first encoding vectors and the second encoding vector.

19. The storage medium according to claim 16, wherein the step of determining, according to the network requirement feature of the service block, the first encoding vector for characterizing the network requirement feature of the service block comprises:
ranking, according to different priorities of the network requirement features of the service blocks, the network requirement features of the service blocks to acquire a first network feature sequence;
sequentially determining feature values of respective network features in the first network feature sequence; and
constructing, according to the feature values of the respective network features in the first network feature sequence, the first encoding vector for characterizing the service block.

20. The storage medium according to claim 19, wherein the step of constructing, according to the feature values of the respective network features in the first network feature sequence, the first encoding vector for characterizing the service block comprises:
inputting the feature values of the respective network features in the first network feature sequence into a trained vector conversion model; and
acquiring the first encoding vector outputted by the trained vector conversion model, wherein the trained vector conversion model is acquired by training with a plurality of positive samples and a plurality of negative samples.
